(19) United States
(12) Patent Application Publication
(10) Pub. No.: US 2014/0134304 A1
(43) Pub. Date: May 15, 2014

(54) Culinary Systems and Methods for Making a Mixed Food Item

(71) Applicant: Sunbeam Products, Inc., Boca Raton, FL (US)

(72) Inventors: Augusto A. Picozza, Boca Raton, FL (US); Omar Bermudez, Pompano Beach, FL (US)

(73) Assignee: Sunbeam Products, Inc., Boca Raton, FL (US)

(21) Appl. No.: 14/081,357

(22) Filed: Nov. 15, 2013

Related U.S. Application Data
(60) Provisional application No. 61/726,739, filed on Nov. 15, 2012.

(51) Int. Cl. A47J 43/07

(52) U.S. Cl. CPC A47J 43/0716
USPC 426/231; 366/142

(57) ABSTRACT

Systems (100) and methods (700) for making a mixed food item. The methods comprise creating a seal between an inner container of a culinary tool and an outer container of the culinary tool such that at least one ingredient of the mixed food item is prevented from exiting the culinary tool. The culinary tool is configured to at least facilitate measurement of a volume of the ingredient necessary to make the mixed food item. The inner container is rotated relative to the outer container of the culinary tool so that the seal is at least partially broken, whereby the ingredient is dispensed from the culinary tool into the culinary appliance.

### BACKGROUND OF THE INVENTION

1. Statement of the Technical Field

The inventive arrangements relate to culinary appliances and culinary tools. More particularly, the invention concerns culinary tools for culinary appliances which are configured to at least facilitate the measurement of volumes for ingredients of a mixed food item.

2. Description of the Related Art

There are various methods for making a mixed drink or other mixed food item using a blender. In many cases, a person incorrectly measures one or more ingredients of the mixed food item. The incorrect measurements can result from the person's lack of knowledge of the proper recipe for the mixed food item, the number of tools needed to measure and/or prepare (e.g., strain) the plurality of different ingredients required to make the mixed food item, and/or the absence of a tool required to precisely measure the amount of one or more ingredients (e.g., ice) for simultaneously making a given number of mixed food items (e.g., two or more mixed drinks). Therefore, there is a need for a single comprehensive culinary tool which can be used with a culinary appliance (e.g., a blender) for ensuring that all ingredients of one or more mixed food items are able to be properly measured every time with (a) minimal knowledge of the recipes and/or (b) limited access to a plurality of culinary tools (e.g., measuring cups, cooking sieves, etc.). The comprehensive culinary tool needs to decrease the number of overall cooking means (e.g., measuring cups, cooking sieves, funnels, glasses, and/or cook books) required to make one or more mixed food items simultaneously or sequentially via the culinary appliance (e.g., a blender).

### SUMMARY OF THE INVENTION

The present invention concerns culinary apparatus and methods for making a mixed food item. The methods involve creating a seal between an inner container of a culinary tool and an outer container of the culinary tool such that at least one ingredient of the mixed food item is prevented from exiting culinary tool. The culinary tool is generally configured to at least facilitate measurement of a volume of each ingredient necessary to make the mixed food item and the disposition of the ingredient(s) into another container (e.g., the culinary appliance and/or a storage container). For example, the outer container is generally configured to at least facilitate the stable coupling of the culinary tool to a culinary apparatus (as will become evident below), while the inner container is generally configured to at least facilitate the measurement of ingredient volumes and the disposition of the ingredient into the culinary apparatus without spilling.

Next, a first flange of the culinary tool is inserted into a central aperture formed through a first lid of a culinary appliance. The first flange protrudes vertically downward and away from a first exterior surface of the culinary tool. Notably, the ingredient(s) can be disposed in the inner container of the culinary tool prior to or subsequent to inserting the first flange into the central aperture formed in the first lid. The culinary tool is then lowered until a second flange thereof rests on top of the first lid. The second flange protrudes horizontally outward and away from the first exterior surface of the culinary tool. Subsequently, the inner container is rotated in a first direction relative to the outer container of the culinary tool so that the seal is at least partially broken, whereby the ingredient(s) can be dispensed from the culinary tool into the culinary appliance. The seal is at least partially broken when a first aperture formed through a bottom sidewall of the inner container is at least partially aligned with a second aperture formed through a bottom sidewall of the outer container.

In some scenarios, the methods also involve controllably adjusting a variable flow rate of the ingredient(s) as it(they) is(are) dispensed from the culinary tool. The flow rate can be controlled by (a) using first indicators printed on or affixed to at least one visible surface of the culinary tool and/or (b) rotating the inner container relative to the outer container of the culinary tool. The first indicators may indicate a degree of alignment or misalignment of first and second apertures. Second indicators may also be printed on or affixed to the visible surface of the culinary tool that indicate recipes for one or more mixed food items. Third indicators may further be printed on or affixed to the visible surface of the culinary tool which are useful for measuring volumes of at least one ingredient necessary to make one or more mixed food items

The culinary appliance can include, but is not limited to, a blender. In this case, the culinary appliance can be used to perform mixing or blending operations while the culinary tool rests on top of the first lid. Notably, the inner container can be turned in a second direction (opposed from the first direction) relative to the outer container so as to re-create the seal so that the ingredient(s) do(es) not spray out of the culinary appliance during the mixing or blending operations. Alternatively, the first lid can be replaced with a second lid or a removable portion can be inserted into the central aperture of the first lid prior to performing the mixing or blending operations with the culinary appliance. The second lid is absent a central aperture. Additionally, the culinary tool can include a cooking sieve and/or a guide provided or integrated therewith. In this case, the culinary tool can be further used to: separate wanted elements of the ingredient(s) from unwanted elements of the ingredient(s) as the ingredient(s) is(are) dispensed from the culinary tool; and/or funnel or guide ingredient(s) into a storage container with a relatively small opening for receiving the ingredient(s).

The culinary apparatus comprises a culinary appliance and a culinary tool. The culinary appliance has a first lid with a central aperture formed therethrough. The culinary tool is configured to at least facilitate measurement of a volume of at least one ingredient necessary to make a mixed food item. In this regard, the culinary tool comprises an outer container, an inner container, a sealing element and an optional cooking sieve.

The outer container has a plurality of flanges. A first flange protrudes vertically downward and away from a first exterior surface of the outer container. The first flange is sized and shaped to be inserted into the central aperture formed through the first lid of a culinary appliance. A second flange protrudes horizontally outward and away from the first exterior surface of the outer container. The second flange is configured to rest on the first lid when the first flange is inserted into the central aperture formed through the first lid of the culinary appliance. In some scenarios, the outer container comprises a third flange. The third flange protrudes out and away from the first exterior surface of the outer container so as to be encompassed by the first flange. The third flange is configured to guide the ingredient(s) from the culinary tool into a storage container, which has a relatively small opening for receiving the ingredient(s).

The inner container is disposed within and coupled to the outer container such that the inner container can be rotated relative to the outer container. In this regard, the inner container is transitionable between a first position in which the ingredient(s) can be dispensed from the culinary tool and a second position in which the ingredient(s) is(are) prevented from being dispensed from the culinary tool. The optional cooking sieve is generally configured to separate wanted elements of the ingredient from unwanted elements of the ingredient as the ingredient(s) are dispensed from the culinary tool.

The sealing element is coupled to the inner container and configured to create a seal between the inner container and the outer container. The seal is at least partially broken when the inner container is rotated relative to the outer container. More particularly, the seal is at least partially broken when a first aperture formed through a bottom sidewall of the inner container is at least partially aligned with a second aperture formed through a bottom sidewall of the outer container.

Notably, the flow rate of the ingredient(s) can be controllably adjusted as the ingredient(s) is(are) dispensed from the culinary tool. The flow rate can be controlled using first indicators printed on or affixed to at least one visible surface of the culinary tool. The first indicators indicate a degree of alignment or misalignment of a first aperture formed through a bottom sidewall of the inner container and a second aperture formed through a bottom sidewall of the outer container. Second and third indicators may also be printed on or affixed to the visible surface of the culinary tool. The second indicators indicate a recipe for the mixed food item. The third indicators indicate information that is useful for measuring a volume of each ingredient necessary to make the mixed food item.

The culinary appliance can include, but is not limited to, a blender. In this case, the culinary appliance can be used to perform mixing or blending operations while the culinary tool rests on top of the first lid. Alternatively, the first lid is replaced with a second lid or a removable lid portion is inserted in to the central aperture of the first lid prior to when the mixing or blending operations are performed by the culinary appliance. The second lid is absent of a central aperture.

### BRIEF DESCRIPTION OF THE DRAWINGS

Embodiments will be described with reference to the following drawing figures, in which like numerals represent like items throughout the figures, and in which:

FIG. 1 is a block diagram of an exemplary culinary system that is useful for understanding the present invention.

FIG. 2 is a perspective view of a lid to a blending container of the culinary system shown in FIG. 1.

FIG. 3 is front view of a culinary tool of the culinary system shown in FIG. 1.

FIG. 4 is a perspective view of the culinary tool shown in FIG. 3.

FIGS. 5-6 each provide an assembly view of the culinary tool shown in FIGS. 1, 3 and 4.

FIG. 7 is a flow diagram of a method for making a mixed drink using the exemplary culinary system of FIG. 1.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects as illustrative. The scope of the invention is, therefore, indicated by the appended claims. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

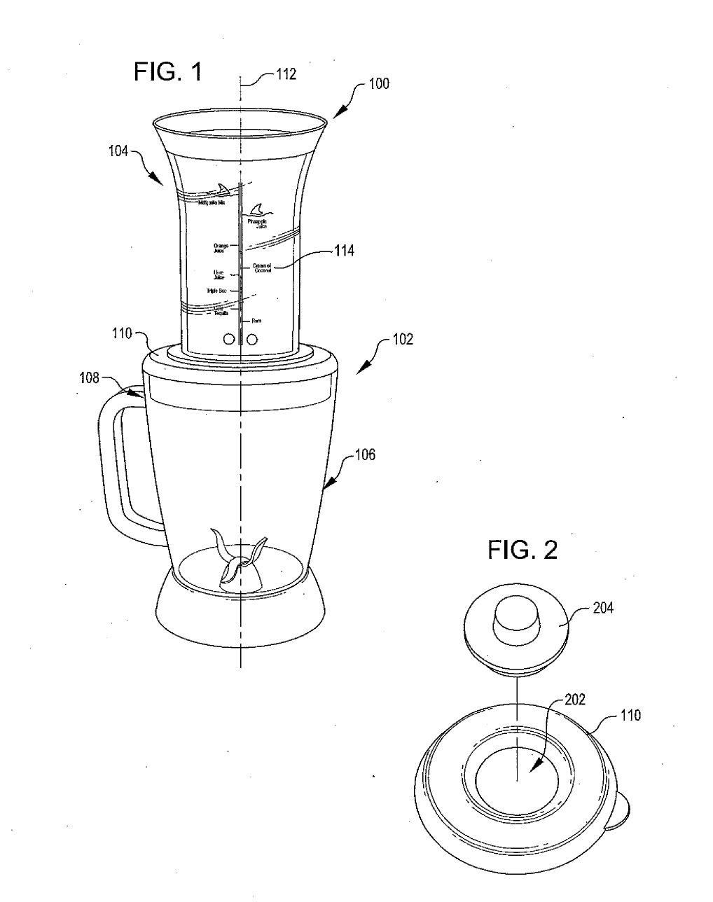

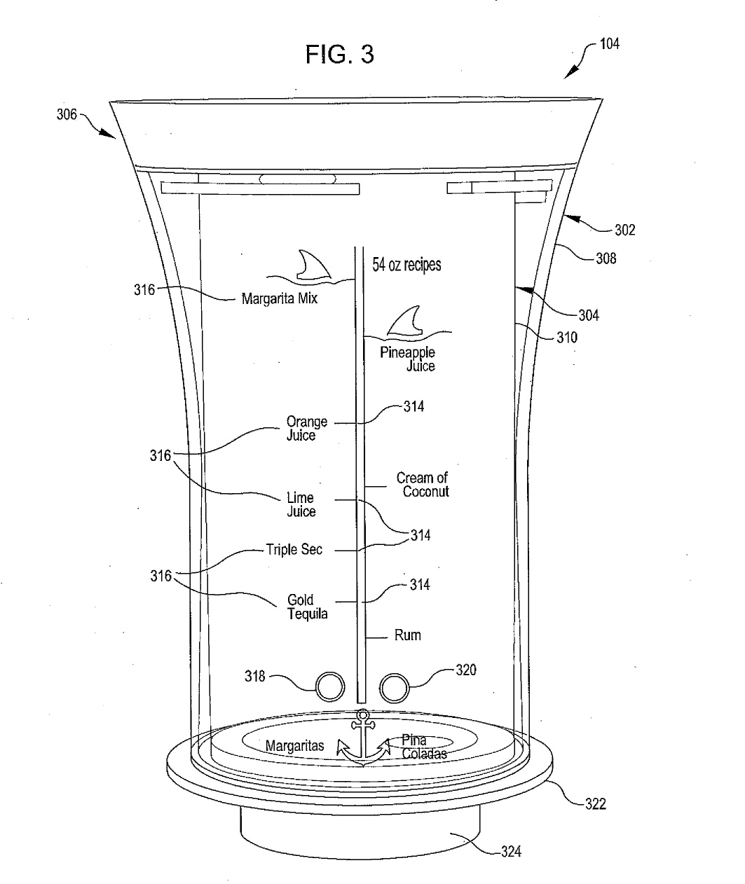

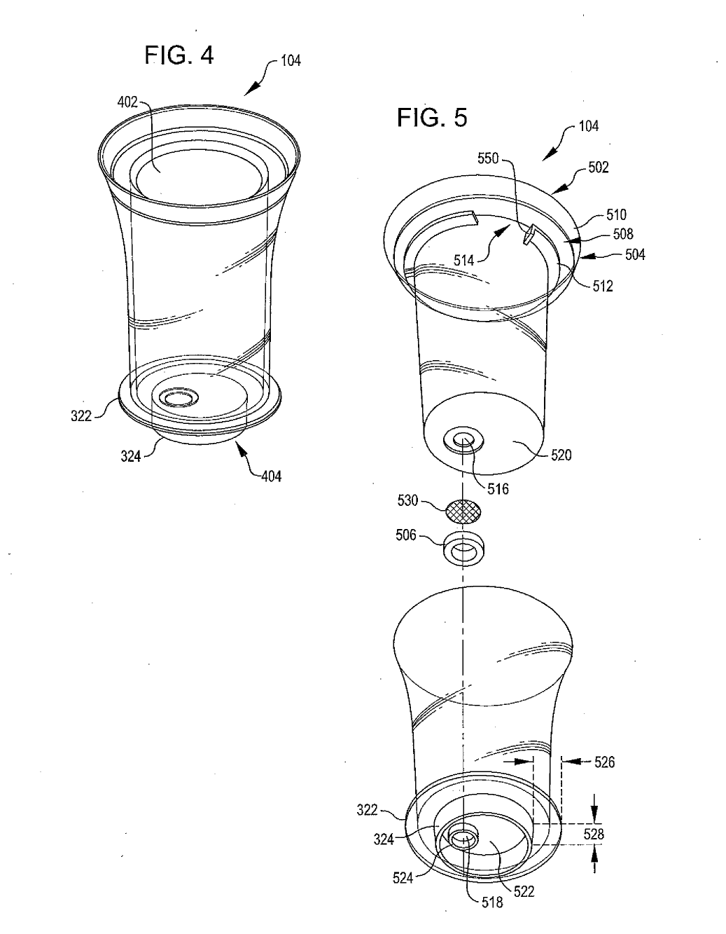

Embodiments will now be described with respect to FIGS. 1-7. Embodiments generally relate to culinary systems. An exemplary architecture 100 for the culinary systems is provided in FIG. 1. As shown in FIG. 1, culinary system 100 comprises a culinary apparatus 102 and a culinary tool 104. The culinary tool 104 is generally configured to facilitate providing the correct amount of ingredients of a mixed food item (e.g., a drink) recipe into a culinary apparatus 102. In this regard, the culinary tool 104 eliminates the need for the person making a mixed food item (e.g., a cocktail or frozen beverage) to remember the corresponding recipe because indicators 114 of the ingredients and required amounts thereof are provided on a visible surface of the culinary tool 104, as shown in FIGS. 1 and 3. The culinary tool 104 will be described in detail below.

In some scenarios, the culinary apparatus 102 comprises, but is not limited to, a an appliance including but not limited a blender having a motorized base and electronic controls (not shown) for mixing a plurality of ingredients together to form a mixed food item (e.g., a cocktail or frozen beverage). In this case, the blender may be the same as or substantially similar to the Margaritaville® Frozen Concoction Maker® and all other related line of products available from Sunbeam Products, Inc. In all cases, the culinary apparatus 102 comprises a container 106 with an opening formed at a top end 108 thereof. The opening is sized and shaped to receive at least a portion of a lid.

Notably, a novel lid 110 is provided (a) in addition to a conventional lid (not shown) of the culinary apparatus 102 or (b) as an alternative to the conventional lid (not shown) of the culinary apparatus 102. In both scenarios (a) and (b), the lid 110 has an architecture that is different than that of conventional lids for culinary apparatus (e.g., a blender). A top perspective view of the lid 110 is provided in FIG. 2. As shown in FIGS. 1-2, the lid 110 has an aperture 202 formed therethrough that is sized and shaped to receive at least a portion of the culinary tool 104. Notably, conventional lids of culinary apparatus (e.g., a blender) are absent of such an aperture 202, and therefore cannot be used with culinary tool 104 as discussed herein.

In scenario (a) described in the immediate previous paragraph, lid 110 may be replaced with a conventional lid (not shown) prior to use of the culinary apparatus 102 for the mixing/blending operations. In scenario (b), the culinary apparatus 102 may be used while the culinary tool 104 rests on top of the lid 110 so that the ingredients does not spray out of the container 106 during mixing/blending operations. Alternatively, the lid 110 may comprise a removable portion 204 configured to be removably and sealingly disposed within the aperture 202 when the culinary apparatus 102 is in use so that the ingredient(s) do(es) not spray out of the container 106 during mixing/blending operations. In this regard, the lid 110 and/or removable portion 204 are formed of any material, such a plastic and/or a rubber, which ensures that the removable portion 204 fits securely in the aperture 202 of the lid 110 creating a seal therebetween. In some scenarios, the lid 110 and/or removable portion 204 comprise an O-ring gasket for creating such a seal, as well as a handle.

Prior to performing the mixing/blending operations, the culinary tool 104 is used to measure one or more ingredients necessary to make the mixed food item (e.g., a cocktail or frozen beverage). In this regard, the culinary tool 104 is configured to have the following purposes: (1) act as a recipe guide such that the need for a cookbook is eliminated when making each of a plurality of mixed food items; (2) simultaneously act as a measuring cup for measuring the volume of each of a plurality of ingredients having the same and/or different required amounts; (3) act as a cooking sieve or sifter for separating wanted elements from unwanted elements as at least one ingredient flows out of the culinary tool 104; (4) act as a funnel or guide to direct ingredients into the container 106 via the aperture 202 formed through the lid 110 of the culinary apparatus 102; (5) act as a mechanism to controllably adjust a variable flow rate of the ingredients flowing out from the culinary tool 104; and (6) act as a funnel or guide to direct the ingredients into a storage container (not shown) without spilling, wherein the storage container has a top opening with a diameter significantly smaller than the diameter of aperture 202 formed through the lid 110 of the culinary apparatus 102.

The particularities of the culinary tool 104 will now be described in detail in relation to FIGS. 3-6. Referring now to FIGS. 3-6, the culinary tool 104 comprises an outer container 302, an inner container 304, a gasket 506, and an optional sieve 530. The containers 302, 304 may be constructed of various materials. The materials include, but are not limited to, shatter proof materials to prevent accidental breakage (e.g., plastic), materials that are easily cleaned (e.g., plastic), and/or materials which will not break when cooled during refrigeration.

The containers 302, 304 may have various different shapes that improve functionality (e.g., facilitate pouring, facilitate mixing, and/or increase structural strength) and/or that improve the aesthetic qualities of the culinary tool 104. For example, as shown in FIGS. 3-6, the outer container 302 may have a cylindrical shape with a varying diameter such that it tapers outward at a top end 306 thereof. In contrast, the inner container 304 has a generally cylindrical shape with a fixed diameter along a significant portion of its length (e.g., greater than 50% of its length has a fixed diameter). A top end 502 of the inner container 304 may have a cylindrical shape with a varying diameter. At least a portion of the inner container 304 is sized and shaped to fit within the outer container 302. Embodiments of the present invention are not limited to the architectures of the outer and inner containers 302, 304 shown in FIGS. 3-6.

The containers 302, 304 are configured to be rotatably coupled to each other such that they can be transitioned between a fill position and a release position simply by rotating at least one of the containers 302, 304 relative to the other. In the fill position, ingredients can be disposed in an inner cavity 402 of the inner container 304 without flowing out therefrom. As such, when the containers 302, 304 are in their fill positions the culinary tool 104 can act as: a recipe guide such that the need for a cookbook is eliminated when making each of a plurality of mixed food items; and/or simultaneously act as a measuring cup for measuring the volume of each of a plurality of ingredients having the same and/or different required amounts.

In the release position, the ingredients residing in the inner cavity 402 of the inner container 304 are allowed to flow out of the bottom 404 of the culinary tool 104. Accordingly, when the containers 302, 304 are in their release positions the culinary tool 104 can act as: a cooking sieve or sifter for separating wanted elements from unwanted elements as at least one ingredient flows out of the culinary tool 104; a funnel or guide to direct the ingredient(s) into the container 106 via the aperture 202 formed through the lid 110 of the culinary apparatus 102 without spilling; a mechanism to controllably adjust a variable flow rate of the ingredient(s) flowing out from the culinary tool 104; and/or a funnel or guide to direct the ingredient(s) into a storage container without spilling, wherein the storage container has a top opening with a diameter significantly smaller (e.g., less than half the size) than the diameter of aperture 202 formed through the lid 110 of the culinary apparatus 102.

As shown in FIGS. 3-6, the containers 302, 304 each have a respective coupling structure 504, 602 formed at the top end 502, 604 thereof. In some scenarios, the coupling structure 504 of the inner container 304 comprises an insert space 508 formed between a top flange 510 and a bottom flange 512. The insert space 508 is sized and shaped to receive the protrusions 606, 608 of the coupling structure 602 of the outer container 302. Notably, the top flange 510 extends entirely around a circumference of the inner container 304. In contrast, the bottom flange 512 comprises one or more portions that extend only partially around the circumference of the inner container 304. As such, at least one slot 514 is provided for allowing the protrusion(s) 606, 608 of the outer container 302 to be inserted into the insert space 508 formed between a top flange 510 and a bottom flange 512 of the inner container 304. When the protrusion(s) 606, 608 reside(s) within the insert space 508, the outer and inner containers 302, 304 are coupled to each other.

In some scenarios, the containers 302, 304 are fixedly coupled to each other. In other scenarios, the containers 302, 304 are removably coupled to each other so that they can be separately cleaned. Accordingly, the outer container 302 may have one or more alignment structures (not shown) formed on an inner surface thereof for ensuring that the two containers 302, 304 are vertically and horizontally aligned with one another when the inner container 304 is disposed within the outer container 302. The alignment structure can include, but is not limited to, at least one protrusion extending out and away from an inner surface of the outer container 302. The protrusion may extend entirely or partially around the circumference of the inner surface of the outer container 302, and may be located within at least the bottom half of the outer container 302.

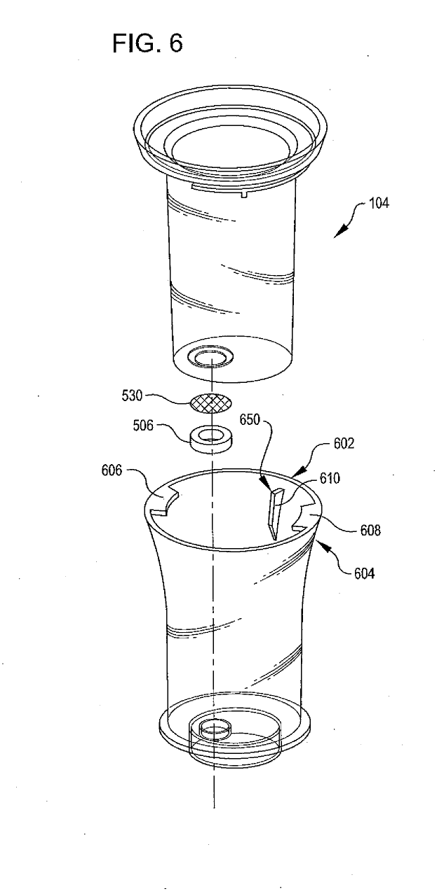

As shown in FIGS. 5-6, each container 302, 304 has an aperture 516, 518 formed in a bottom wall 520, 522 thereof. When the apertures 516, 518 are aligned, the ingredient(s) (e.g., fluid(s) or liquid(s)) is(are) allowed to flow out of the culinary tool 104. In some scenarios, a sieve is disposed within at least one of the apertures for separating wanted elements from unwanted elements as the ingredient(s) flow(s) out of the culinary tool 104. For example, as shown in FIGS. 3-6, a sieve 530 is disposed in aperture 516 of the inner container 304. Embodiments of the present invention are not limited in this regard. Additionally or alternatively, another sieve (not shown) is disposed in aperture 518 of the outer container 302. In all scenarios, the sieves 530 can be formed of a mesh material. In the scenarios where a sieve is provided in both apertures 516 and 518, the mesh materials of the two sieves can have the same or different mesh size. Meshes with different mesh sizes allow particulates of various sizes to be filtered in two separate stages. One benefit to having two stages of sieves is the prevention of the mesh passageways from being clogged by particulates, whereby the ingredient(s) is(are) unable to flow out of the culinary tool 104. Notably, each of the sieves can be a removable and exchangeable component of the culinary tool 104 such that the user can select the size and/or type of particulate to be filtered when ingredient(s) flow(s) out of the culinary tool 104.

When the apertures 516, 518 are misaligned, the ingredient(s) is(are) prevented from flowing out of the culinary tool 104. The gasket 506 facilitates the prevention of ingredients from flowing out of the culinary tool 104. In this regard, the gasket 506 is affixed to the bottom wall 520 of the inner container 304 so as to encompass the aperture 516. The gasket 506 ensures that the ingredient(s) do(es) not flow out of the inner container 304 when the apertures 516, 518 are misaligned by creating a seal between the bottom walls 520, 522. In some scenarios, creation of this seal is facilitated by the bottom flange 512 of the coupling structure 504 formed at the top end 502 of the inner container 304. The bottom flange 512 may have a varying thickness such that (a) the gasket 506 is pressed between the bottom walls 520, 522 when the containers 302, 304 are in their fill positions so as to create the seal, and (b) the gasket 506 is not pressed between the bottom walls 520, 522 when the containers 302, 304 are in their release positions (such that the seal is broken). Alternatively, the bottom flange 512 has a constant thickness such that the gasket 506 is pressed between the bottom walls 520, 522 when the containers 302, 304 are in their fill positions and release positions. In this case, the user is still able to rotate the container(s) relative to each other, but with slightly more difficulty as a result of the frictional engagement between the gasket and the corresponding surface of the outer container 302. The seal is at least partially broken when the gasket resides above the aperture 518 of the outer container 302.

Notably, a structure 610 is provided to stop the inner container 304 from rotating relative to the outer container 302 at a particular point along the circumference of the outer container 302. In this regard, the structure 610 has a surface 650 configured to engage a surface 550 of the inner container 304 so as to prevent further rotation of the containers relative to each other.

As noted above, the culinary tool 104 has indicators 114 disposed thereon. The indicators 114 can be printed on and/or otherwise affixed to an outer surface 308 of the outer container 302 and/or an outer surface 310 of the inner container 304. The indicators 114 are provided to communicate certain information to a user of the culinary tool 104. The indicators 114 may further comprise symbols 318, 320 for indicating when the containers 302, 304 are in their fill positions and/or their release positions. In some scenarios, the symbols 318, 320 each have a generally circular shape and reside at locations in which (a) they are vertically and horizontally aligned with each other when the apertures 516, 518 formed on the bottom walls 520, 522 of the containers 302, 304 are aligned with each other and (b) are misaligned when the apertures 516, 518 are misaligned.

Notably, the symbols 318, 320 facilitate the controlled adjustment of the variable flow rate of ingredient dispensed from the culinary tool 104. In this regard, it should be appreciated that the symbols 318, 320 indicate the degree of alignment or misalignment of the apertures 516, 518. Therefore, a user of the culinary tool 104 is continuously provided knowledge of the actual flow rate of the ingredient(s) being dispensed from the culinary tool 104. The user also has the ability to change the flow rate simply be rotating at least one of the containers relative to the other.

The indicators 114 may also include gradation marks 314 and text 316. The gradation marks 314 may indicate the level to fill each ingredient (e.g., orange juice, lime juice, and margarita mix) for making a particular mixed food item (e.g., a cocktail or frozen beverage). The gradation marks 314 may be incremented in accordance with standard measurements (e.g., cups, quarter cups, and table spoons). Additionally or alternatively, the gradation marks 314 may correspond to text 316 relating to specific recipe quantities and preparation procedures (e.g., add lime juice to a first gradation mark, and then add orange juice to a next gradation mark). The text 316 may comprise recipes or other information relating to the preparation of at least one particular mixed food item (e.g., a cocktail or frozen beverage).

As shown in FIGS. 3-6, the culinary tool 104 has three flanges 322, 324, 524 formed at the bottom thereof so as to fully encompass aperture 518 of the outer container 302. Flanges 322 and 324 are provided to align and stably couple the culinary tool 104 to the lid 110 of the culinary apparatus 102 such that at least one ingredient can be dispensed from the culinary tool 104 and into the container 106 of the culinary apparatus 102 without any spilling. In this regard, flange 324 has a diameter which is slightly less than the diameter of the aperture 202 formed in the lid 110. When flange 324 is disposed within aperture 202, a mechanical and/or frictional engagement may be created therebetween for facilitating the stable coupling of the culinary tool 104 to the culinary apparatus 102. Flange 322 has a horizontal dimension 526 and flange 324 has a vertical dimension 528 suitable to ensure that the culinary tool 104 cannot be or only slightly rocked side-to-side when resting on top of the culinary apparatus 102. Flange 322 and lid 110 may be designed such that a mechanical engagement can be provided therebetween when the culinary tool 104 is disposed on the culinary apparatus 102. The mechanical structures for creating such a mechanical engagement are not shown for simplicity purposes. However, such mechanical structures can include, but are not limited to, cavities formed on the lid 100 and mating protrusions formed on the flange 322. These mating mechanical structures may also facilitate the rotation of the inner container 304 relative to the outer container 302 since the outer container's movement would be restricted as a result of the mechanical engagement.

When the culinary tool 104 is stably coupled to lid 110 of the culinary apparatus 102, its central axis 112 is vertically and/or horizontally aligned with central axis of the lid 110 and the container 106. Such alignment at least partially ensures that the culinary apparatus 102 will not topple over when the culinary tool 104 is being used by a user since the weight of the ingredient(s) disposed in the culinary tool 104 is evenly distributed around the axis 112. Notably, the culinary tool 104 can be coupled to the lid 110 prior to or subsequent to filling the inner container 304 with the ingredient(s).

Flange 524 is provided to align and stably couple the culinary tool 104 to a storage container (not shown) for one or more ingredients (e.g., a bottle or jar for juice) such that the ingredient(s) can be dispensed from the culinary tool 104 and into the storage container without spilling In some scenarios, flange 524 has a constant diameter which is slightly larger than that of aperture 518. In other scenarios, flange 524 has a diameter with a variable size such that the flange 524 is defined by a tapered wall. Such a tapered flange can act as a funnel to guide liquid into the storage container. In both cases, flange 524 may be a detachable component of the culinary tool 104. This detachable configuration has certain advantages. For example, a user can select which of a plurality of different sized and/or shaped funnels to use for guiding ingredients being dispensed from the culinary tool 104 into the storage container.

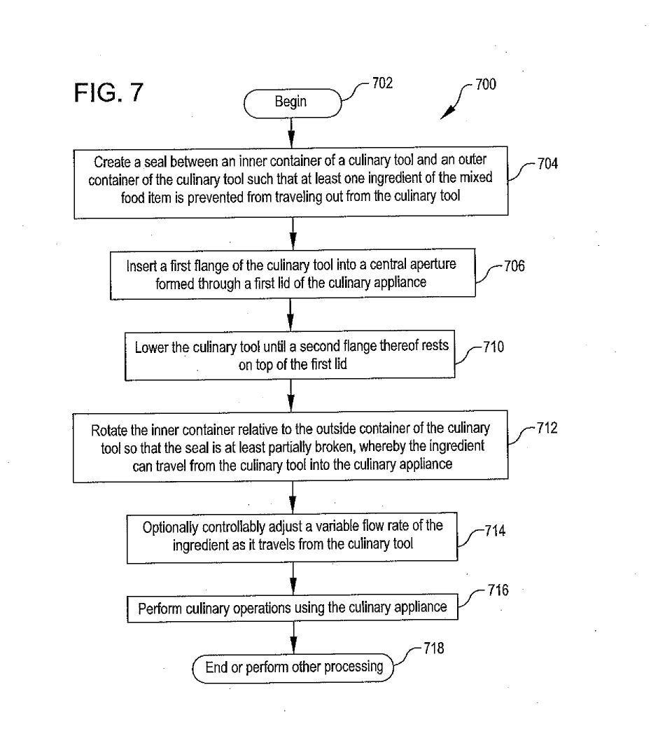

Referring now to FIG. 7, there is provided a flow diagram of an exemplary method 700 for making a mixed food item (e.g., a cocktail or frozen beverage). Method 700 begins with step 702 and continues with step 704. Step 704 involves creating a seal between an inner container (e.g., inner container 304 of FIG. 3) of a culinary tool (e.g., culinary tool 104 of FIG. 1) and an outer container (e.g., outer container 302 of FIG. 3) of the culinary tool such that at least one ingredient of the mixed food item is prevented from traveling out from the culinary tool. The culinary tool is configured to at least facilitate measurement of a volume of the ingredient necessary to make the mixed food item.

Next in step 706, a first flange (e.g., flange 324 of FIG. 3) of the culinary tool is inserted into a central aperture (e.g., aperture 202 of FIG. 2) formed through a first lid (e.g., lid 110 of FIGS. 1-2) of a culinary appliance. The first flange protrudes vertically downward and away from a first exterior surface of the culinary tool. Notably, the ingredient can be disposed in the inner container of the culinary tool prior to or subsequent to inserting the first flange into the central aperture formed in the first lid. The culinary tool is then lowered in step 710 until a second flange (e.g., flange 322 of FIG. 3) thereof rests on top of the first lid. The second flange protrudes horizontally outward and away from the first exterior surface of the culinary tool. Subsequently in step 712, the inner container is rotated relative to the outer container of the culinary tool so that the seal is at least partially broken, whereby the ingredient can travel from the culinary tool into the culinary appliance. The seal is at least partially broken when a first aperture formed through a bottom sidewall of the inner container is at least partially aligned with a second aperture formed through a bottom sidewall of the outer container.

In some scenarios, the methods also involve controllably adjusting a variable flow rate of the ingredient(s) as it travels from the culinary tool, as shown by optional step 714. The flow rate can be controlled by (a) using first indicators printed on or affixed to at least one visible surface of the culinary tool and/or (b) rotating the inner container relative to the outer container of the culinary tool. The first indicators may indicate a degree of alignment or misalignment of first and second apertures. Second indicators may also be printed on or affixed to the visible surface of the culinary tool that indicate recipes for one or more mixed food items. Third indicators may further be printed on or affixed to the visible surface of the culinary tool which are useful for measuring volumes of each ingredient necessary to make one or more mixed food items.

In a next step 716, the culinary appliance performs various culinary operations. The culinary appliance can include, but is not limited to, a blender. In this case, the culinary appliance can be used to perform mixing or blending operations while the culinary tool rests on top of the first lid. Alternatively, the first lid can be replaced with a second lid or a removable portion 204 can be inserted into the central aperture of the first lid prior to performing the mixing or blending operations with the culinary appliance. The second lid is absent of a central aperture. Additionally, the culinary tool can include a cooking sifter and/or a guide integrated therewith. In this case, the culinary tool can be further used to: separate wanted elements of the ingredient from unwanted elements of the ingredient as the ingredient travels out of the culinary tool; and/or funnel or guide ingredients into a storage container.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for making a mixed food item, comprising:
creating a seal between an inner container of a culinary tool and an outer container of the culinary tool such that at least one ingredient of the mixed food item is prevented from being dispensed from the culinary tool, where the culinary tool is configured to at least facilitate measurement of a volume of the ingredient necessary to make the mixed food item;
inserting a first flange protruding vertically downward and away from a first exterior surface of the culinary tool into a central aperture formed through a first lid of a culinary appliance;
lowering the culinary tool until a second flange rests on top of the first lid, the second flange protruding horizontally outward and away from the first exterior surface of the culinary tool; and
rotating the inner container relative to the outer container of the culinary tool so that the seal is at least partially broken, whereby the ingredient can be dispensed from the culinary tool into the culinary appliance.

2. The method according to claim 1, wherein the seal is at least partially broken when a first aperture formed through a bottom sidewall of the inner container is at least partially aligned with a second aperture formed through a bottom sidewall of the outer container.

3. The method according to claim 1, further comprising controllably adjusting a variable flow rate of the ingredient as it is dispensed from the culinary tool to the culinary appliance using indicators printed on or affixed to at least one visible surface of the culinary tool that indicate a degree of alignment or misalignment of first and second apertures.

4. The method according to claim 1, further comprising disposing the ingredient in the inner container of the culinary tool prior to or subsequent to inserting the first flange into the central aperture formed in the first lid.

5. The method according to claim 1, further comprising using the culinary appliance to perform mixing or blending operations while the culinary tool rests on top of the first lid.

6. The method according to claim 5, further comprising replacing the first lid with a second lid prior to performing mixing or blending operations with the culinary appliance, wherein the second lid is absent said central aperture.

7. The method according to claim 1, further comprising inserting a removable portion of the first lid into the central aperture prior to performing mixing or blending operations with the culinary appliance.

8. The method according to claim 1, further comprising using indicators printed on or affixed to at least one visible surface of the culinary tool to determine a recipe for a mixed food item.

9. The method according to claim 1, further comprising using indicators printed on or affixed to at least one visible surface of the culinary tool to measure a volume of each ingredient necessary to make the mixed food item.

10. The method according to claim 1, further comprising controllably adjusting a variable flow rate of the ingredient as it is dispensed from the culinary tool to the culinary appliance.

11. The method according to claim 10, wherein the variable flow rate is controllably adjusted by rotating the inner container relative to the outer container of the culinary tool.

12. The method according to claim 1, further comprising using a sieve integrated with the culinary tool to separate wanted elements of the ingredient from unwanted elements of the ingredient as the ingredient is dispensed from the culinary tool.

13. The method according to clam 1, further comprising using a guide structure affixed to the culinary tool to direct the ingredient into a storage container which has an opening for receiving the ingredient with a diameter smaller than a diameter of the central aperture of the first lid.

14. The method according to claim 1, wherein the seal is created by rotating the inner container relative to the outer container of the culinary tool so as to cause a gasket to be compressed between a bottom wall of the inner container and a bottom wall of the outer container.

15. A culinary apparatus, comprising:
a culinary appliance having a first lid with a central aperture formed therethrough; and
a culinary tool configured to at least facilitate measurement of a volume of at least one ingredient necessary to make a mixed food item, the culinary tool comprising
an outer container comprising
a first flange protruding vertically downward and away from a first exterior surface of the outer container, the first flange sized and shaped to be inserted into the central aperture formed through the first lid of a culinary appliance, and
a second flange protruding horizontally outward and away from the first exterior surface of the outer container and configured to rest on the first lid when the first flange is inserted into the central aperture formed through the first lid of the culinary appliance; and
an inner container disposed within and coupled to the outer container such that the inner container can be rotated relative to the outer container so as to be transitionable between a first position in which the ingredient can be dispensed from the culinary tool and a second position in which the ingredient is prevented from being dispensed from the culinary tool.

16. The culinary apparatus of claim 15, further comprising a sealing means coupled to the inner container and configured to create a seal between the inner container and the outer container.

17. The culinary apparatus of claim 16, wherein the seal is at least partially broken when the inner container is rotated relative to the outer container.

18. The culinary apparatus according to claim 16, wherein the seal is at least partially broken when a first aperture formed through a bottom sidewall of the inner container is at least partially aligned with a second aperture formed through a bottom sidewall of the outer container.

19. The culinary apparatus according to claim 15, wherein a variable flow rate of the ingredient is controllably adjusted as it is dispensed from the culinary tool to the culinary appliance using indicators printed on or affixed to at least one visible surface of the culinary tool that indicate a degree of alignment or misalignment of a first aperture formed through a bottom sidewall of the inner container and a second aperture formed through a bottom sidewall of the outer container.

20. A culinary tool, comprising:
a body configured to at least facilitate measurement of a volume of at least one ingredient necessary to make a mixed food item, the body comprising
an outer container comprising
a first flange protruding vertically downward and away from a first exterior surface of the outer container, the first flange sized and shaped to be inserted into a central aperture formed through a lid of a culinary appliance, and
a second flange protruding horizontally outward and away from the first exterior surface of the outer container and configured to rest on the lid when the first flange is inserted into the central aperture formed through the lid of the culinary appliance; and
an inner container disposed within and coupled to the outer container such that the inner container can be rotated relative to the outer container so as to be transitionable between a first position in which the ingredient can be dispensed from the culinary tool and a second position in which the ingredient is prevented from being dispensed from the culinary tool.
